(19) United States
(12) Patent Application Publication
(10) Pub. No.: US 2024/0175453 A1
(43) Pub. Date: May 30, 2024

(54) HYDRAULIC PRE-SWITCHING DEVICE

(71) Applicant: Scanwill Fluid Power ApS, Smørum (DK)

(72) Inventor: Jesper Will Iversen, Smørum (DK)

(21) Appl. No.: 18/521,669

(22) Filed: Nov. 28, 2023

(30) Foreign Application Priority Data
Nov. 28, 2022 (EP) 22209922.8

(51) Int. Cl. F15B 11/10; F15B 13/02; F15B 15/20

(52) U.S. Cl. CPC F15B 11/10; F15B 13/024; F15B 15/20

(57) ABSTRACT

A hydraulic pre-switching device for feeding a single-acting hydraulic cylinder with working pressure hydraulic fluid directly or via a pressure transformer and for actively withdrawing used hydraulic fluid from the hydraulic cylinder when retracting the piston rod. The pre-switching device includes a hydraulic motor and a discharge pump coupled thereto as well as a reversing valve. The reversing valve and the hydraulic motor are connected in such a way that the reversing valve in a switching position has a connection for the hydraulic cylinder, bypassing the hydraulic motor, and the unloading pump is supplied with hydraulic fluid under working pressure and, in a different switching position, feeds the hydraulic motor with hydraulic fluid under feed pressure, which thereby drives the discharge pump, which applies negative pressure to a connection for the hydraulic cylinder.

### TECHNICAL FIELD

The invention relates to a hydraulic pre-switching device, a hydraulic pre-switching system, a hydraulic working arrangement, and a method for the accelerated retraction of a hydraulic cylinder.

### BACKGROUND OF THE INVENTION

In hydraulics, hydraulic cylinders are used to generate linear movements. For this purpose, hydraulic fluid is pumped under pressure into the cylinder, causing a piston located within the cylinder to move along the longitudinal axis of the cylinder due to the increasing pressure. The movement of the piston can then be utilized in a working device with the help of a piston rod connected to the piston, protruding from the cylinder.

In this context, a distinction can be made between single-acting and double-acting hydraulic cylinders.

While double-acting hydraulic cylinders can be actively moved in two directions by applying pressure, single-acting hydraulic cylinders can only be actively moved in one direction. This is because a single-acting hydraulic cylinder, unlike a double-acting one, has only one connection for the hydraulic fluid or is supplied with hydraulic fluid from only one side. Through this single connection or side, the hydraulic fluid causing the movement of the piston is pumped into the cylinder, and after the piston's movement, it is withdrawn to the desired position.

Conventional single-acting hydraulic cylinders typically incorporate a compression spring that acts against the direction of the piston's movement caused by the hydraulic fluid pumped into the cylinder.

As soon as the connection pumping the hydraulic fluid into the cylinder is depressurized, the spring forces the piston back to its initial position, displacing the hydraulic fluid out of the cylinder.

In particular when the hydraulic cylinder needs to perform multiple stroke movements within a short period of time, this setup can pose challenges.

Depending on the force of the spring used, it may occur that the fluid remaining in the hydraulic cylinder after the piston's stroke might be displaced slowly or incompletely out of the cylinder.

While it's conceivable to always use a spring with relatively high force, this would compromise the efficiency of the hydraulic cylinder.

Moreover, depending on the application, hydraulic cylinders often require very high pressure to operate the hydraulic fluid.

This can pose challenges when attempting to utilize an existing hydraulic system to operate a hydraulic cylinder that was not originally part of the system.

For instance, this occurs when a commercial vehicle's hydraulic system is used to power an attachable and detachable hydraulic working device.

The hydraulic cylinders in such hydraulic working devices frequently demand significantly higher operating pressures than what is available in the existing vehicle's hydraulic system.

Based on this it is the objective of the invention to disclose a hydraulic pre-switching device, for which the hydraulic fluid used for the stroke of a single-acting hydraulic cylinder can be quickly and effectively withdrawn from the cylinder after the stroke is completed.

### SUMMARY OF THE INVENTION

Accordingly, the problem is solved with a hydraulic pre-switching device for directly feeding or feeding via a pressure transformation device of a single-acting hydraulic cylinder with hydraulic fluid which is under working pressure.

In addition the pre-switching device serves for actively withdrawing used hydraulic fluid from the hydraulic cylinder while the piston rod is reintroduced.

It is characterized in that the pre-switching device comprises a hydraulic motor and a discharge pump coupled to it, as well as a reversing valve.

The reversing valve and the hydraulic motor are connected in such a way that the reversing valve, in a switching position, applies hydraulic fluid under working pressure to a connection for the hydraulic cylinder, bypassing the hydraulic motor and the discharge pump.

In another switching position, the reversing valve feeds the hydraulic motor with hydraulic fluid under feed pressure.

The hydraulic motor thereby drives the unloading pump, which applies negative pressure to a connection for the hydraulic cylinder.

This is preferably the same connection to which the reversing valve supplies hydraulic fluid under working pressure in its first switching position. However, it is also conceivable to provide two separate connections.

The pre-switching device can either be equipped with a feed pump, a tank and a motor driving the feed pump and thus represent the entire hydraulic system required to operate the hydraulic cylinder.

However, it is also conceivable to couple the pre-switching device to an existing feed pump, which pumps hydraulic fluid from an existing tank, driven by an already existing motor.

The second option is suitable if a hydraulic cylinder or a working device comprising a hydraulic cylinder is to be connected to an existing hydraulic system.

Depending on whether the pressure of the feed pump is sufficient to operate the hydraulic cylinder in the desired manner, a pressure transformer can be provided between the pre-switching device and the hydraulic cylinder.

If no pressure transformer is used between the pre-switching device and the hydraulic cylinder to be fed, the working pressure under which the hydraulic fluid is pumped into the hydraulic cylinder corresponds to the pressure applied by the feed pump.

However, if a pressure transformer is provided, the pressure under which the hydraulic fluid moves the piston of the hydraulic cylinder into the desired position is higher than the feed pressure applied by the feed pump.

With the help of a reversing valve in the pre-switching device, it is possible to set whether the hydraulic cylinder should be fed or whether the hydraulic fluid already in the hydraulic cylinder should be withdrawn from the hydraulic cylinder. The removal takes place actively.

This means that the pressure in the hydraulic cylinder is not displaced from the hydraulic cylinder by the mere spring action of a compression spring present in the hydraulic cylinder.

Rather, the used hydraulic fluid is pumped out of the hydraulic cylinder by applying a negative pressure to the corresponding connection of the hydraulic cylinder. For this purpose, the pre-switching device is equipped with a hydraulic motor and a discharge pump.

The reversing valve in the pre-switching device can assume at least two positions. In the feed positions, the hydraulic fluid pumped from a tank by the feed pump is pumped through one or more hydraulic lines of the pre-switching device, which lead to the connection of the hydraulic cylinder or—if one is available—to a connection of the pressure transformer.

Thereby the hydraulic motor provided in the pre-switching device is not driven. In a second withdrawal position of the reversing control valve, the feed pump pumps the hydraulic fluid from the tank towards the hydraulic motor, which drives the discharge pump.

The unloading pump in turn pumps the used hydraulic fluid from the hydraulic cylinder into a tank. Ideally, this is the same tank as the one from which the feed pump pumps the hydraulic fluid. The pressure with which the discharge pump pumps out the used hydraulic fluid from the hydraulic cylinder does not have to correspond to the pressure of the feed pump.

The advantage of such a pre-switching device is that the hydraulic fluid is not displaced from the hydraulic cylinder by the mere displacement effect of the spring-loaded piston.

As a result of the active pumping out of used hydraulic fluid, the removal of used hydraulic fluid from the hydraulic cylinder is significantly faster.

It also ensures that the hydraulic fluid is completely withdrawn. Another advantage of a separate discharge pump (which preferably also means a correspondingly driven, pumping hydraulic motor) is that the feed pump is always operated at a constant pressure and therefore at an operating point with ideal efficiency. In addition, it is also conceivable to operate several hydraulic cylinders connected in parallel to a feed pump synchronously or asynchronously using one pre-switching device per hydraulic cylinder.

A “hydraulic cylinder” is understood to be a working cylinder for applying externally required mechanical work or force.

A hydraulic cylinder is “single-acting” if the hydraulic fluid is fed into the hydraulic cylinder in such a way that always the same end face of the piston arranged in the hydraulic cylinder is subjected to working pressure.

The hydraulic fluid in the hydraulic cylinder is considered “used” at the moment when the piston of the hydraulic cylinder has been moved to the desired position as a result of the hydraulic cylinder being supplied with hydraulic fluid and should return to its original position.

A “pressure transformer” is a cylinder in which a first piston and a second piston are rigidly connected to one another in the direction of movement of the pistons and arranged in such a way that when the pressure exerted by a fluid on the first piston is constant, the second piston exerts a pressure to a fluid which is changed dependent on the area ratio of the two pistons.

The “working pressure” is the operating pressure of the hydraulic cylinder, i.e. the pressure that brings the piston of the hydraulic cylinder into the desired position. If no pressure transformer is provided between the pre-switching device and the hydraulic cylinder, the working pressure is the feed pressure applied by the feed pump. However, if a pressure transformer is used, the working pressure is higher than the feed pressure.

The “feed pressure” is the pressure generated directly by the pump that applies the pressure to operate the pre-switching device.

In any case, a fluid is considered a “hydraulic fluid” if it has an average compression modulus of >1 GPa.

Furthermore, it is the object of the invention to provide a hydraulic pre-switching system with which the hydraulic fluid required for the operation of a single-acting hydraulic cylinder can be provided to the hydraulic cylinder under high pressure.

The solution to the aforementioned problem is achieved with a hydraulic pre-switching system, which consists of a hydraulic pre-switching device according to the invention and a pressure transformer to increase the working pressure of the hydraulic fluid feeding the hydraulic cylinder.

The pressure transformer is thereby located hydraulically between the hydraulic pre-switching device and the hydraulic cylinder.

The hydraulic pre-switching system is characterized in that a bypass line (POV) is provided, via which the discharge pump can withdraw hydraulic fluid from the hydraulic cylinder, completely bypassing the pressure transformer or bypassing its pressure booster element comprising a pressure booster piston. The pressure booster piston is preferably differential piston-shaped.

The use of such a pre-switching system is advantageous when an existing hydraulic system is used to operate the hydraulic cylinder, but the pressure applied by the existing feed pump is not sufficiently high.

In order to prevent the used hydraulic fluid to be withdrawn from the hydraulic cylinder from first having to pass through the pressure transformer or its pressure transformer element, a bypass line is provided.

By this the efficiency and speed when pumping out the used hydraulic fluid from the hydraulic cylinder is not reduced despite the use of a pressure transformer when feeding.

The bypass line can either be integrated into the pressure transformer or provided in addition to it.

If it is integrated into the pressure transformer, only the pressure transformer element of the pressure transformer is bypassed when the hydraulic fluid is withdrawn from the hydraulic cylinder.

Before the hydraulic fluid pumped by the feed pump in the direction of the pre-switching device reaches the hydraulic cylinder, it passes through the pressure transformer.

In this, the pressure acting on the hydraulic fluid is increased, so that the pressure acting on the piston of the hydraulic cylinder is ultimately higher than the feed pressure applied by the feed pump.

The pressure transformer ideally has a transmission ratio of at least 1:2. It is even better if the pressure transformer has a transmission ratio of 1:4. The transmission ratio reflects the factor by which the feed pressure is increased by the pressure transformer.

The pressure booster element of the pressure transformer comprises a low-pressure piston, which is subjected to the feed pressure, and a high-pressure piston, which applies the higher working pressure to the fluid.

The low-pressure piston and the high-pressure piston are rigid and ideally designed in a two-part manner.

In this context, two-part means that they are manufactured separately and only connected to one another when they are assembled.

The connection can either be detachable (for example in the form of a screw connection) or non-detachable (which is achieved, for example, by welding, pressing or gluing).

It is also not necessary that the low-pressure piston be connected directly to the high-pressure piston, but it is quite conceivable that an additional element connecting the two is provided.

In principle, it is also conceivable that the low-pressure and high-pressure pistons are connected to one another in one piece or are manufactured in one piece.

The latter is achieved, for example, if the low-pressure piston and the high-pressure piston are manufactured from a single blank by forging, turning or milling.

The high-pressure piston and the low-pressure piston are each arranged in their own high-pressure or low-pressure cylinder, with the high-pressure piston being at least partially introduced into the low-pressure cylinder during operation of the pressure transformer.

The high-pressure cylinder and the low-pressure cylinder ideally merge into one another in one piece. Alternatively, the high-pressure cylinder and the low-pressure cylinder are attached to one another in such a way that no hydraulic fluid can escape at the gap between the two cylinders.

The end face of the low-pressure piston is ideally at least twice, and better even at least four times, as large as the end face of the high-pressure piston.

The “pressure booster element” corresponds to the element of the pressure transformer, which is responsible for increasing the pressure.

The pressure booster element is therefore the composition of high-pressure and low-pressure cylinders as well as the high-pressure and low-pressure pistons located therein.

A piston has a “differential piston shape” if it has at least one shoulder so that the face at one end of the piston has a smaller diameter than the face at the other end of the piston.

In addition, it is the object of the invention to provide a device that can form or replace the drive of a hydraulically operated device.

The solution to the aforementioned problem is achieved with a hydraulic working arrangement, consisting of a single-acting hydraulic cylinder and connected to it a hydraulic pre-switching device or pre-switching system according to the invention.

Such a hydraulic working arrangement can be integrated as a whole into a hydraulic working device. The single-acting hydraulic cylinder then causes the movement to be carried out by the hydraulic working device.

Such a hydraulic working device is understood to mean all working devices that, for their intended use, carry out a movement caused by a single-acting hydraulic cylinder. For example, this can be a lifting platform or a hydraulic spreader, such as is used to rescue trapped accident victims from a vehicle wreck.

A working arrangement that is equipped with a hydraulic pre-switching system according to the invention with a pressure transformer comes into consideration in particular when a hydraulic working device is to be connected to an already existing hydraulic system such as the vehicle hydraulics of a commercial vehicle and from which the pressure that can be applied to the existing hydraulic system is too low to operate the working device.

In addition, it is the object of the invention to provide a method with which the hydraulic fluid used for the stroke of a single-acting hydraulic cylinder can be quickly and effectively withdrawn from the cylinder despite a pressure booster used to feed the hydraulic cylinder.

The solution to the aforementioned problem is achieved using a method for the accelerated reintroduction of a hydraulic cylinder fed with the aid of a pressure transformer.

The method is characterized in that the pressure transformer or its pressure booster element is bypassed when the hydraulic fluid is pumped out of the hydraulic cylinder by opening a bypass line. In addition, a discharge pump is started during reintroduction.

Using the bypass line, this draws used hydraulic fluid out of the hydraulic cylinder directly, without having to go through the pressure booster element.

Such a method makes it possible to quickly and completely withdraw the used hydraulic fluid from the hydraulic cylinder.

This applies even if a pressure transformer is used, since this or at least its pressure booster element is not flowed through due to the bypass channel when used hydraulic fluid is withdrawn from the hydraulic cylinder.

The flow resistance is therefore kept low.

The discharge pump is started by moving the reversing valve of the pre-switching device into a position that causes the discharge pump to start.

There are a number of possibilities for designing the invention in such a way that its effectiveness or usability is further improved.

It is therefore particularly preferred that the pre-switching device has a first hydraulic node, into which one end of a first hydraulic line opens, the other end of which is connected to a first pressure level of the reversing valve.

In addition, one end of a second hydraulic line opens into the first hydraulic node, the other end of which is connected to a second pressure level of the reversing valve and in which the hydraulic motor is located.

As an alternative to the second hydraulic line, a further hydraulic line is provided which does not open into the first hydraulic node, in which the hydraulic motor is located and one end of which is always at the tank pressure level.

In addition, one end of a third hydraulic line opens into the first hydraulic node, the other end of which is preferably connected directly to the connection for the hydraulic cylinder.

Furthermore, one end of a fourth hydraulic line opens into the first hydraulic node. The discharge pump is located in the fourth hydraulic line and the other end of the fourth hydraulic line is connected to the third hydraulic line via a second node.

The first pressure level of the reversing valve corresponds to the feed pressure generated by the feed pump as long as the feed pump is in operation. The second pressure level of the reversing valve corresponds to the pressure level prevailing in the tank. Ideally this is ambient pressure.

The hydraulic pre-switching device is always connected to the reversing valve with two hydraulic lines.

In the two positions of the reversing valve, in which either the hydraulic cylinder is supplied with hydraulic fluid or hydraulic fluid is withdrawn from the hydraulic cylinder, there is a different pressure level on the two hydraulic lines connected to the reversing valve.

In this way, by simply reversing the first and second pressure levels on the reversing valve, it can be decided whether feed pressure or tank pressure, i.e. negative pressure, is present at the connection for the hydraulic cylinder.

A “hydraulic node” is a connection between at least two hydraulic lines, which basically allows the hydraulic fluid to flow from one line into the at least one other line.

It is indeed advantageous if the third hydraulic line opening into the first hydraulic node is directly connected to the hydraulic cylinder. However, it is entirely conceivable that at least one further node and at least one further line are provided between the third hydraulic line and the hydraulic cylinder.

In a further preferred embodiment, there is a preferably automatic check valve in the second hydraulic line, which prevents flow from the first node to the hydraulic motor.

In this way, when feed pressure is present on the first hydraulic line of the hydraulic pre-switching device protruding into the first hydraulic node due to a corresponding position of the reversing valve, it can be prevented that feed pressure flows against the hydraulic motor and the discharge pump is put into operation.

This ensures that the hydraulic motor does not cause an unwanted pumping effect of the unloading pump when feeding the hydraulic cylinder.

The check valve is ideally a simple ball check valve, as they are robust and cost-effective.

In a further preferred embodiment, the hydraulic line provided instead of the second hydraulic line connects the hydraulic motor to a hydraulic node that is permanently at the tank pressure level.

As a result, the hydraulic fluid always flows back into the tank after passing through the hydraulic motor, bypassing the reversing valve. This has the advantage that when hydraulic fluid is pumped out of the hydraulic cylinder, the reversing valve is not flowed through by both the hydraulic fluid flowing through the hydraulic motor towards the tank and the hydraulic fluid withdrawn from the hydraulic cylinder and can therefore be dimensioned smaller.

Ideally, there is a check valve in the third hydraulic line, which prevents flow from the connection of the hydraulic cylinder to the first node bypassing the unloading pump.

The hydraulic fluid withdrawn from the hydraulic cylinder is prevented by the check valve in the third hydraulic line from flowing through the third hydraulic line and consequently past the discharge pump in the direction of the first hydraulic node.

This check valve therefore ensures that the discharge pump does not run empty when the used hydraulic fluid is withdrawn from the hydraulic cylinder.

The check valve can either be an automatic check valve, for example in the form of a simple ball check valve. Alternatively, a controlled check valve can also be provided.

In a further preferred embodiment, the check valve in the third hydraulic line is an externally controlled valve. The externally controlled valve is controlled by a pre-switching line and is closed as long as feed pressure is applied to the hydraulic motor. If there is tank pressure on the hydraulic motor, it is open.

By this it can be ensured that the hydraulic fluid pumped out of the hydraulic cylinder by the unloading pump in the direction of the reversing valve cannot flow via the third hydraulic line in the direction of the hydraulic cylinder after passing the unloading pump.

While automatic check valves, for example, only have one flow opening, i.e. only have one main valve, which is opened as soon as there is fluid under pressure in the flow direction, “externally controlled” valves must first be supplied with an additional pre-switching flow (or control flow).

Only this ensures that the valve opens. Alternatively, externally controlled valves can be designed so that they are always closed as long as there is no additional pre-switching flow flowing against them and only open when a corresponding pre-switching flow is present.

An externally controlled valve therefore has an additional connection to the connection through which the fluid that is actually to be controlled by the valve flows.

A “pre-switching line,” which can also be referred to as a “control line,” is a hydraulic line through which hydraulic fluid can flow in order to bring a valve into a specific position.

With regard to the externally controlled valve in the third hydraulic line mentioned here, “open” ideally means that the path is clear as a result of the flow of hydraulic fluid under feed pressure from the direction of the reversing valve. However, it can also mean that it is permanently open and can be flowed through.

Preferably, there is a preferably automatic check valve in the fourth hydraulic line, which prevents flow from the first hydraulic node through the fourth hydraulic line via the unloading pump.

This check valve prevents hydraulic fluid from flowing in the direction from the first hydraulic node to the unloading pump.

This prevents hydraulic fluid from flowing from the first hydraulic node under feed pressure through the discharge pump when feeding the hydraulic cylinder and causing it to move.

In particular, since the unloading pump is connected to the hydraulic motor in such a way that a rotation of the unloading pump would also be accompanied by a rotation of the drive shaft and the elements of the hydraulic motor connected to it in a rotationally fixed manner, unwanted wear can be avoided in this way.

The hydraulic motor is essentially free of hydraulic fluid at the time the hydraulic cylinder is supplied. Since the hydraulic fluid usually also serves as a lubricant and coolant for the moving components of the pre-switching device that come into contact with the hydraulic fluid, dry operation of the hydraulic motor would result in increased signs of wear.

In a further preferred embodiment, there is an externally controlled valve in the fourth hydraulic line between the second node and the unloading pump.

The control line of this valve is hydraulically coupled to the hydraulic motor in such a way that this valve is always unlocked when the hydraulic motor is fed with hydraulic fluid under feed pressure.

If this externally controlled valve is unlocked, the hydraulic fluid can be withdrawn using the discharge pump. When feeding, however, the externally controlled valve remains blocked.

This prevents the hydraulic fluid under feed pressure coming from the third hydraulic line from flowing in the direction of the unloading pump after passing the second hydraulic node.

This prevents undesirable (at least partial) rotation of the unloading pump and the hydraulic motor coupled to it, which leads to damage or undesirable wear, particularly in the hydraulic motor that may not be filled with hydraulic fluid at this point in time and is therefore unlubricated.

Ideally, the bypass line is controlled by an externally controlled valve. This is preferably a valve in the form of a pre-switching valve controlled by the feed pressure.

This valve remains closed as long as the hydraulic cylinder is supplied with hydraulic fluid and is opened as soon as hydraulic fluid is withdrawn from the hydraulic cylinder.

The externally controlled valve determines whether the hydraulic fluid can flow past the pressure booster element or must pass through it when it is pumped from the hydraulic cylinder back to the tank or from the tank to the hydraulic cylinder.

The externally controlled valve remains closed during the feeding process.

The hydraulic fluid must therefore flow into the hydraulic cylinder via the pressure booster element and is thereby subjected to a higher working pressure by the pressure booster element than the feed pressure generated by the feed pump.

However, when the hydraulic fluid is withdrawn from the hydraulic cylinder, the valve is opened and the hydraulic fluid can flow past the pressure booster element.

As long as there is tank pressure on the pre-switching line of the externally controlled pre-switching valve provided for controlling the valve, which is the case due to the corresponding position of the reversing valve of the pre-switching device during the feeding process, the valve remains closed.

Only when the reversing valve of the pre-switching device assumes its second position and the externally controlled pre-switching valve is supplied with hydraulic fluid under feed pressure via its pre-switching line does the valve open.

The pressure transformer is preferably a pressure transformer which draws its working and control energy exclusively from the hydraulic fluid fed in under feed pressure.

On the low-pressure side, the pressure transformer has a first and a second connection for feeding in hydraulic fluid under feed pressure and for discharging hydraulic fluid under essentially tank pressure.

On the high-pressure side, the pressure transformer has a third connection for feeding the hydraulic cylinder with hydraulic fluid at a pressure that is higher than the feed pressure and for withdrawing used hydraulic fluid from the hydraulic cylinder.

Thereby the pressure transformer is designed in such a way that its operation “filling the hydraulic cylinder” or “withdrawing hydraulic fluid from the hydraulic cylinder” depends solely on whether the first connection is supplied with feed pressure and the second connection with tank pressure or vice versa.

The pressure transformer therefore draws its working energy from the feed pump. If the first connection of the pressure transformer is supplied with hydraulic fluid under feed pressure, this initiates the “filling of the hydraulic cylinder” mode of operation of the pressure transformer.

Thereby the high-pressure piston of the pressure booster element is supplied with hydraulic fluid under feed pressure via a hydraulic line connected to the first connection of the pressure booster. This moves the pressure booster piston of the pressure booster element to its bottom zero point.

Latest if it has assumed this position, a control line connecting the high-pressure cylinder of the pressure booster element to a path control valve of the pressure transformer, which was previously covered by the high-pressure piston, becomes available.

This causes the said path control valve to assume a position that connects the first connection of the pressure transformer, which is under feed pressure, to the low-pressure cylinder of the pressure booster element. The low-pressure cylinder is then supplied with hydraulic fluid under feed pressure.

As a result, the booster piston is moved in the direction of the high-pressure cylinder, whereby hydraulic fluid under working pressure flows towards the hydraulic cylinder via the third connection of the pressure transformer.

As soon as the booster piston has reached its top zero point, the control line connecting the path control valve of the pressure transformer with the high-pressure cylinder of the pressure booster element is depressurized.

This causes the said path control valve to again assume a position in which the low-pressure piston is connected to the second connection of the pressure transformer, at which tank pressure is present at this point in time.

The work process of the pressure booster element then begins again from the beginning.

As soon as the negative pressure caused by the discharge pump is present at the first connection of the pressure transformer, while feed pressure is present at the second connection of the pressure transformer, the “withdrawal of hydraulic fluid from the hydraulic cylinder” mode of operation is initiated.

This results in the aforementioned externally controlled pre-switching valve releasing the bypass line. The used hydraulic fluid in the hydraulic cylinder is then pumped out via the discharge pump via the third connection of the pressure transformer.

In a further preferred embodiment, the pre-switching device has a path control valve, the switching position of which not only determines whether the hydraulic motor and the discharge pump are running, but also determines whether said first connection of the pressure transformer sees feed pressure or tank pressure. The path control valve also determines whether the said second connection of the pressure transformer sees tank pressure or feed pressure.

The operation of the pressure transformer can therefore be controlled via the position of the path control valve of the pre-switching device.

The path control valve can also be referred to as a reversing valve. The advantage of such a design is that the feed pump can permanently provide a constant pressure. The feed pump can therefore be constantly operated at an operating point with maximum efficiency.

In a further preferred embodiment, the hydraulic pre-switching device has a further hydraulic line, one end of which branches off from the mesh in which the hydraulic motor is also located, upstream of the hydraulic motor.

At its other end, this hydraulic line is connected to the low-pressure side connection of the pressure transformer. The low-pressure side connection of the pressure transformer is at low pressure when filling the hydraulic cylinder and at feed pressure when emptying the hydraulic cylinder.

The low-pressure side connection of the pressure transformer, to which the additional hydraulic line of the pre-switching device is connected, corresponds to the above-mentioned second low-pressure side connection of the pressure transformer.

As soon as the mesh of the pre-switching device, in which the hydraulic motor is located, is supplied with hydraulic fluid under feed pressure, feed pressure is also present at the second low-pressure side connection of the pressure transformer. This condition is achieved when the reversing valve of the pre-switching device assumes the removal position.

However, if the reversing valve of the pre-switching device assumes its feed position, tank pressure is applied to the mesh, the other hydraulic line of the pre-switching device and the second low-pressure side connection of the pressure transformer.

The “low pressure” corresponds to the pressure prevailing in the tank.

Ideally, the pre-switching line branches off from the aforementioned additional hydraulic line, the internal pressure of which depends on whether the externally controlled valve designed as a pre-switching valve, which controls the fourth hydraulic line, is open or closed.

This means that the state of the pre-switching valve can be determined using the reversing valve of the pre-switching device. If there is tank pressure on the pre-switching line, the pre-switching valve remains closed. This is the case when the control valve of the pre-switching device assumes its supply position.

If feed pressure is present, the valve is opened. The latter is the case when the reversing valve assumes its removal position.

The bypass line (POV) is preferably designed completely within the block of the pressure transformer, which is generally made of metal, within which the pressure booster piston is also located.

Preferably, the reversing valve, which determines the working cycles of the pressure booster piston in pressure-boosting operation, is also located within this block. The hydraulic pre-switching device, on the other hand, is preferably designed separately within the common housing.

The bypass line therefore represents a component of the pressure transformer designed as a metal block. The remaining hydraulic lines or control lines of the pressure transformer mentioned above as well as the pressure transformer element are also located in this metal block.

The hydraulic pre-switching device is ideally located in its own block, which is also ideally made of metal. The two metal blocks of the pre-switching device and the pressure transformer are ideally located in a common housing.

### BRIEF DESCRIPTION OF FIGURES

FIG. 1 shows schematically a hydraulic working arrangement according to the invention consisting of a hydraulic cylinder and a hydraulic pre-switching device in the feeding state.

FIG. 2 shows schematically a hydraulic working arrangement according to the invention consisting of a hydraulic cylinder and a hydraulic pre-switching device in the pumping state.

FIG. 3 shows schematically a hydraulic working arrangement according to the invention consisting of a hydraulic cylinder and a hydraulic pre-switching system in the feeding state.

FIG. 4 shows schematically a hydraulic working arrangement according to the invention consisting of a hydraulic cylinder and a hydraulic preliminary system in the pumping-out state.

FIGS. 5-6 show schematically a hydraulic working arrangement according to the invention having a further embodiment of a pre-switching system.

FIGS. 7-8 show schematically a hydraulic working arrangement according to the invention having yet another embodiment of a pre-switching system.

FIGS. 9-12 show schematically the four cycles of a working cycle of a pressure transformer according to the invention

### DETAILED DESCRIPTION OF THE INVENTION

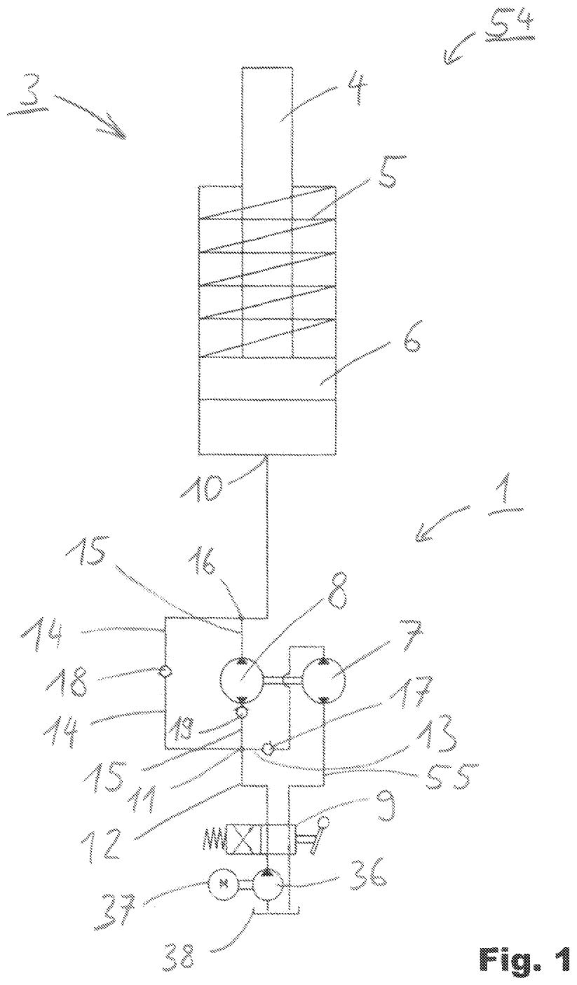

The functionality of the invention is explained below by way of example using FIGS. 1-12.

First, the functionality of a hydraulic pre-switching device 1 is explained with reference to FIGS. 1-4, which is used to feed a hydraulic cylinder 3 with hydraulic fluid and to withdraw the hydraulic fluid from the hydraulic cylinder 3 after the stroke has been completed.

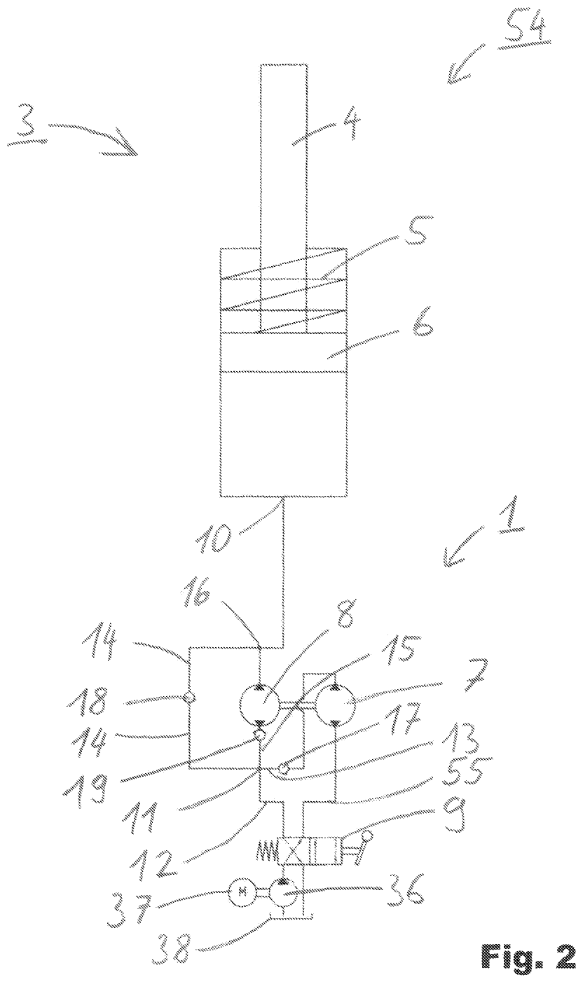

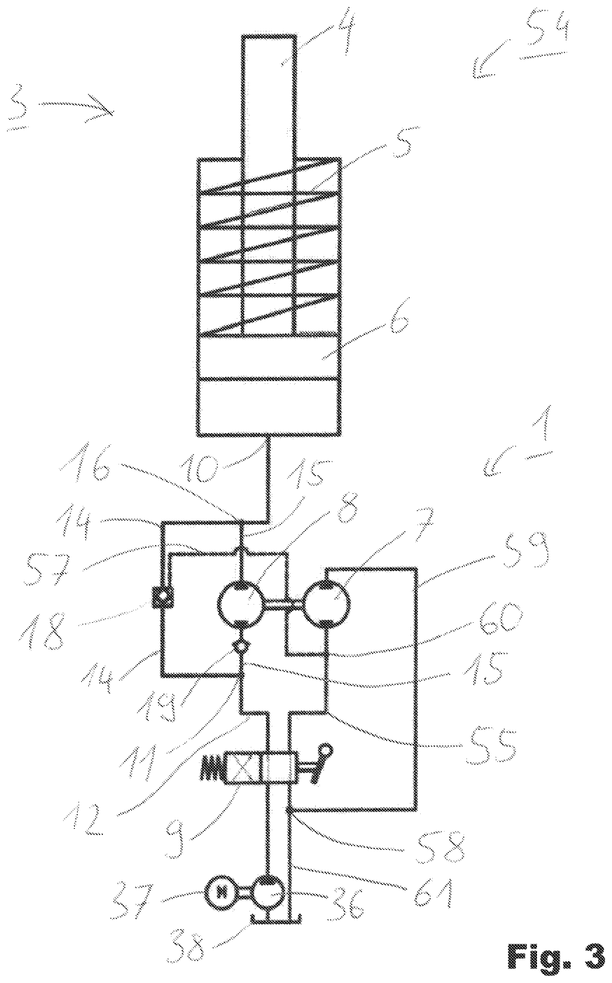

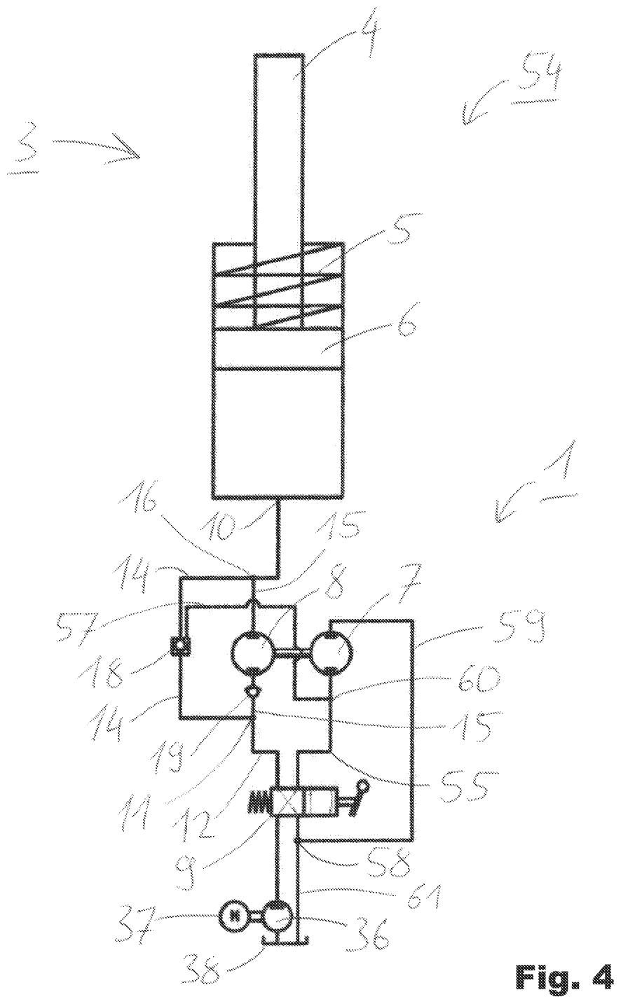

A first exemplary embodiment of such a pre-switching device 1 is shown in FIGS. 1 and 2 and a further exemplary embodiment of such a pre-switching device 1 is shown in FIGS. 3 and 4.

In the hydraulic cylinder 3, a piston 6 and a piston rod 4 rigidly connected to it are arranged in such a way that the piston 6 together with the piston rod 4 moves away from the connection 10 of the hydraulic cylinder 3 when hydraulic fluid is pumped under pressure via the connection 10 in the hydraulic cylinder 3.

The piston rod 4 therefore performs a lifting movement that can be used for a wide variety of applications. The hydraulic cylinder 3 is a single-acting hydraulic cylinder 3, i.e. a hydraulic cylinder that can only be driven in one direction by hydraulic pressure.

For this reason, it only has a single connection 10. When the piston 6 has reached its top zero point, it cannot be replaced by a corresponding supply of hydraulic fluid on the side of the hydraulic cylinder 3 opposite the connection 10 be brought into its starting position.

In order to move the piston 6 together with the piston rod 4 back into its starting position after they have completed a lifting movement, the compression spring 5 is provided, among other things. The spring force of the spring 5 counteracts the movement of the piston 6 while the hydraulic cylinder 3 is supplied with hydraulic fluid.

As soon as the connection 10 of the hydraulic cylinder 3 is depressurized, i.e. no new hydraulic fluid is pumped in and the hydraulic fluid already present in the hydraulic cylinder 3 can flow out via the connection 10, the spring 5 pushes the piston 6 together with the piston rod 4 back into their starting position. The piston 6 displaces hydraulic fluid from the hydraulic cylinder 3, which leaves the hydraulic cylinder 3 through the connection 10.

Since the withdrawal of the hydraulic fluid from the hydraulic cylinder 3 takes a long time as a mere result of the action of the spring 5 on the piston 6 and may not lead to a complete withdrawal of the hydraulic fluid from the hydraulic cylinder, a hydraulic pre-switching device 1 is provided between the hydraulic cylinder 3 and the feed pump 36.

The hydraulic pre-switching device 1 is used both when supplying the hydraulic cylinder 3 with hydraulic fluid and when withdrawing the hydraulic fluid from the hydraulic cylinder 3 after the piston 6 has completed its lifting movement.

In order to supply the hydraulic cylinder 3 with hydraulic fluid, the feed pump 36 driven by the motor 37 sucks in hydraulic fluid from the tank 38 and pumps it under pressure in the direction of the reversing valve 9.

The feed pump 36 can be a part of the inventive pre-switching device integrated into the housing of the feed pump. However, it can also be provided externally, for example because the pre-switching device 1 is connected to an external hydraulic network that works with a central pressure source.

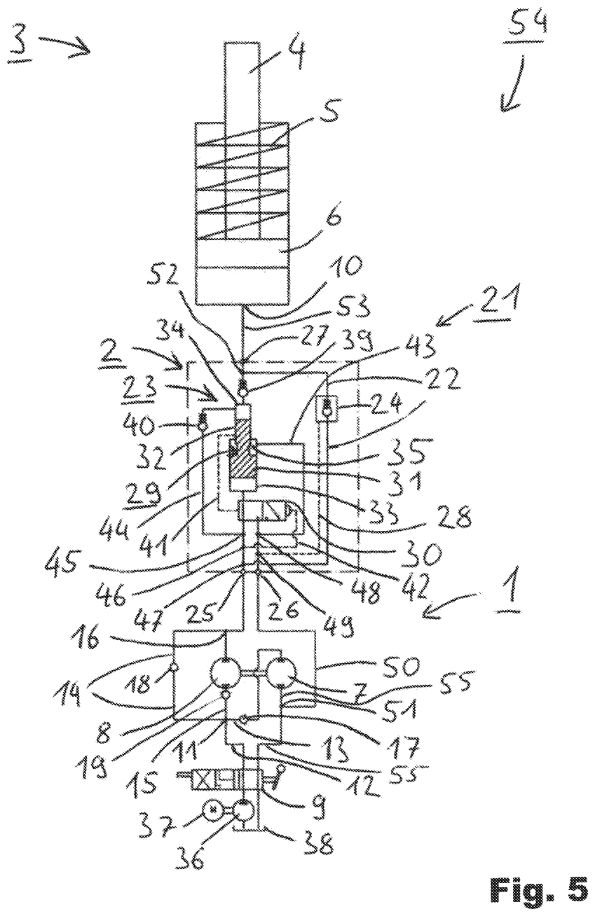

In the exemplary embodiments shown in FIGS. 1-4, the reversing valve 9, which preferably forms an integral part of the pre-switching device according to the invention, can assume two positions. In the exemplary embodiments shown in FIGS. 5-8, the reversing valve 9 can assume three positions.

Since the exemplary embodiment of the pre-switching device 1 shown in FIGS. 3 and 4 has many similarities with the exemplary embodiment shown in FIGS. 1 and 2, the functionality of the pre-switching device 1 according to the invention will first be explained below using the exemplary embodiment shown in FIGS. 1 and 2.

Then the elements of the exemplary embodiment shown in FIGS. 3 and 4 that deviate from the exemplary embodiment shown in FIGS. 1 and 2 and the resulting different functionality will be described.

In FIG. 1 the reversing valve is in its first position. In this, the reversing valve 9 directs the hydraulic fluid pumped under pressure from the feed pump 36 via the hydraulic line 12 in the direction of the first hydraulic node 11.

At this hydraulic node 11, several hydraulic lines 12, 13, 14 and 15 meet, so that there are basically several options for the further path of the hydraulic fluid.

However, a check valve 17 and 19 is provided in the hydraulic lines 13 and 15. These check valves 17 and 19 are arranged in such a way that they block the further path of the hydraulic fluid along the hydraulic lines 13 and 15 in the direction away from the hydraulic node 11.

Instead, the hydraulic fluid can only continue to flow along the hydraulic line 14 and through the check valve 18 which is arranged along it but releases the path in this direction. The hydraulic fluid finally flows further through the node 16 via the hydraulic line 14 and towards the connection 10 of the hydraulic cylinder 3.

This results in the hydraulic fluid being pumped into the hydraulic cylinder 3 with the feed pressure generated by the feed pump 36 and, when the hydraulic cylinder 3 is filled accordingly, causing the piston 6 to move in the direction away from the connection 10.

Starting from node 16, the hydraulic fluid can in principle flow through the hydraulic line 15, which also opens into node 16, to the discharge pump 8.

However, if it flows at all, it only flows up to the check valve 19, since this is now acted upon from both sides by the feed pressure generated by the feed pump 36, thus preventing the hydraulic fluid from flowing further.

In order to prevent the hydraulic fluid from flowing through the unloading pump 8 when feeding the hydraulic cylinder 3 starting from the hydraulic node 16, a further check valve can be arranged between the unloading pump 8 and the hydraulic node 16.

It is advisable to assemble the additional check valve from a main valve and a pre-switching valve. The main valve then prevents hydraulic fluid from flowing through from node 16 to the unloading pump 8 until it is opened with the help of the pre-switching valve.

It is advisable to design the pre-switching valve in such a way that it opens the main valve when hydraulic fluid under feed pressure flows against it, which previously flowed via the hydraulic line 55 and the hydraulic motor 7.

As will be explained below, such a flow occurs via the hydraulic line 55 when the reversing valve 9 is in its second position shown in FIG. 2.

After the stroke of the piston 6 and the piston rod 4 has completed the desired stroke movement, the reversing valve 9 can be brought manually or automatically into the position shown in FIG. 2.

The feed pump 36 continues to pump hydraulic fluid from the tank 38 in the direction of the control valve 9. However, the control valve 9 then does not forward the hydraulic fluid in the direction of the hydraulic line 12, but in the direction of the hydraulic line 55.

Following this, the hydraulic fluid finally flows through the hydraulic motor 7 coupled to the line 55 and from there through the check valve 17 in the direction of the first hydraulic node 11. The further path through the hydraulic lines 15 towards the discharge pump 8 is blocked by the check valve 19.

The only path for the hydraulic fluid therefore leads via the hydraulic line 12, which is completely or at least essentially unpressurized or at tank pressure level at this point in time, to the reversing valve 9 and as well through the hydraulic line 14.

The fluid flowing through the hydraulic line 12 Hydraulic fluid is conveyed to the tank 38 from the reversing valve 9, which is in its second position.

There is a significantly lower pressure in the tank 38 than the feed pressure generated by the feed pump 36. Ideally there is 38 ambient pressure in the tank.

The flow of hydraulic fluid through the hydraulic motor 7 causes the hydraulic motor 7 to perform a rotational movement. Since the hydraulic motor 7 is coupled to the unloading pump 8, the hydraulic motor 7 drives the unloading pump 8.

This causes the unloading pump 8 to generate a negative pressure, which causes the hydraulic fluid to flow from the hydraulic cylinder 3 to the hydraulic node 16 and from there to the unloading pump 8.

Since the check valve 19 opens the way in the direction from the unloading pump 8 to the hydraulic node 11, the hydraulic fluid is pumped from there in the direction of the hydraulic line 15 via the node 11 and the hydraulic line 12 to the tank 38. The discharge pump 8 may also deliver hydraulic fluid towards the check valve 18.

Since the hydraulic fluid arriving from the direction of the hydraulic cylinder 3 at the hydraulic node 16 continues to flow in the direction of the discharge pump 8 and not in the direction of the check valve 18 due to the negative pressure generated by the discharge pump 8, the check valve 18 also allows flow at this time of hydraulic fluid arriving from the hydraulic node 11 via line 14.

However, from the hydraulic node 16, the hydraulic fluid continues to flow in the direction of the discharge pump 8 and not in the direction of the hydraulic cylinder 3 due to the negative pressure generated by the discharge pump 8.

The exemplary embodiment of the pre-switching 1 shown in FIGS. 3 and 4 is described in the following.

In FIG. 3, the reversing valve 9 is in its first position. As in the above exemplary embodiment, the reversing valve 9 directs the hydraulic fluid pumped under pressure by the feed pump 36 via the hydraulic line 12 in the direction of the first hydraulic node 11. Several hydraulic lines 12, 14 and 15 meet one another there. Since a check valve 19 is provided in line 15, which blocks the path for the hydraulic fluid in the direction of the discharge pump 18, the hydraulic fluid flows through line 14 in the direction of valve 18.

The valve 18 arranged along the line 14, which is designed as a pre-switching valve in the exemplary embodiment shown in FIGS. 3 and 4, clears the path for the hydraulic fluid in this direction.

This is because tank pressure is present at this point in time on the pre-switching line 57, which controls the valve position of the pre-switching valve 18. As long as this is the case, the valve 18 is either permanently in its open position or at least opens when hydraulic fluid flows against it from the direction described here.

After the hydraulic fluid has passed the valve 18, it continues to flow to the node 16 and towards the port 10 of the hydraulic cylinder. From this point on, the feeding process of the hydraulic cylinder does not differ from the process already described above.

Also, as in the above exemplary embodiment, the hydraulic fluid cannot flow back towards the tank 38 because of the check valve 19. Regarding the possibility of providing a further valve between the discharge pump 8 and the node 16, reference is made to the description above.

The second valve position of the reversing valve 9, which leads to the withdrawal of the hydraulic fluid in the hydraulic cylinder 3, is shown in FIG. 4.

In the exemplary embodiment shown in FIG. 4, the feed pump 36 pumps hydraulic fluid under feed pressure via the hydraulic line 55 in the direction of the hydraulic motor 7.

This is driven by the hydraulic fluid flowing through it. Since the hydraulic motor 7 is coupled to the unloading pump 8, this leads to the unloading pump 8 being put into operation.

After the hydraulic fluid has passed the hydraulic motor 7, it flows along the hydraulic line 59 in the direction of the node 58. At the node 58, the hydraulic line 59 and the hydraulic line 61 leading to the tank 38 meet one another, so that the hydraulic fluid coming from the hydraulic motor 7 continues flowing in the direction of the tank 38.

The discharge pump 8 put into operation by the hydraulic motor 7 generates (as already above) a negative pressure, which leads to the hydraulic fluid in the hydraulic cylinder 3 being fed via the node 16, the discharge pump 8, the check valve 19 and the line 12 to the Tank 38 is pumped.

In the state shown in FIG. 4, there is only tank pressure at the connection of the check valve 19 facing away from the unloading pump 8, so that the hydraulic fluid coming from the unloading pump 8, which is at a higher pressure than the tank pressure, leads to opening the check valve 19.

While in the example above, the hydraulic fluid pumped by the unloading pump 8, starting from node 11, could basically flow through the valve 18 to node 16 and from there back to the unloading pump 8, in the case of the in FIGS. 3 and 4 shown embodiment, the valve 18 is always closed if valve 9 assumes the second valve position as shown in FIG. 4.

This is due to the pre-switching line 57. This meets the hydraulic line 55 at node 60. Accordingly, in the second valve position of the valve 9 shown in FIG. 4, hydraulic fluid flows under feed pressure via the pre-switching line 57 in the direction of the pre-switching valve 18.

The hydraulic fluid that arrives at the valve 18 and is under feed pressure then brings the valve 18 into its closed position. As long as the valve 9 remains in its second position and hydraulic fluid continues to be pumped under feed pressure via the pre-switching line 57, the valve 18 therefore remains closed.

The functionality of two different exemplary embodiments of a hydraulic pre-switching system 21 is explained with reference to FIGS. 5 to 12.

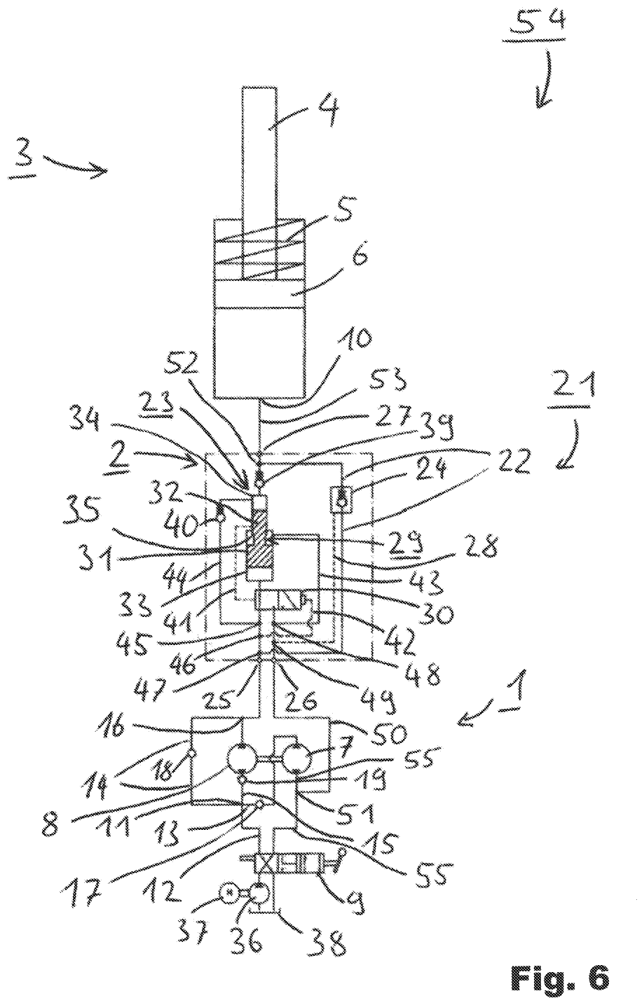

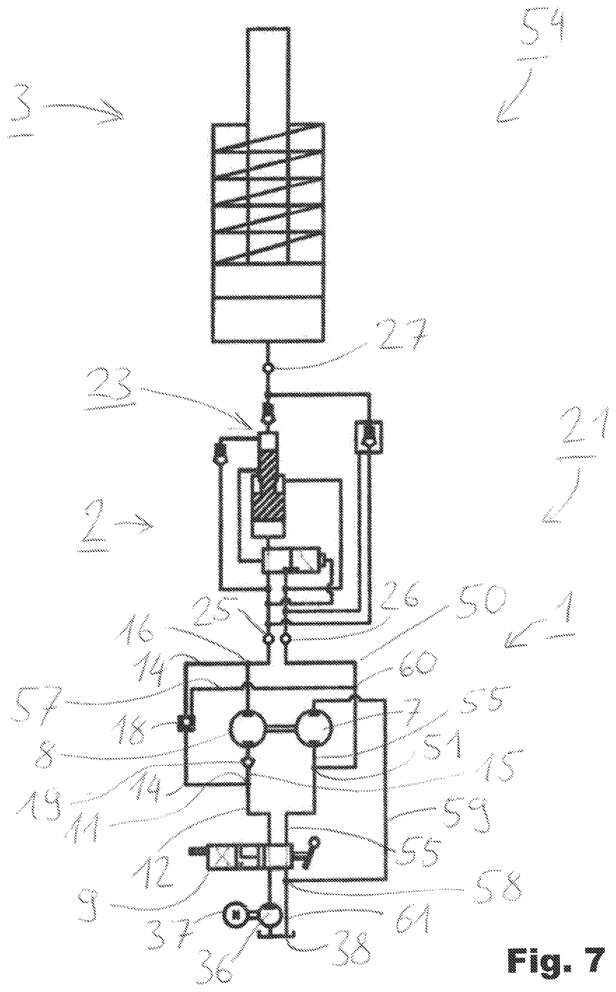

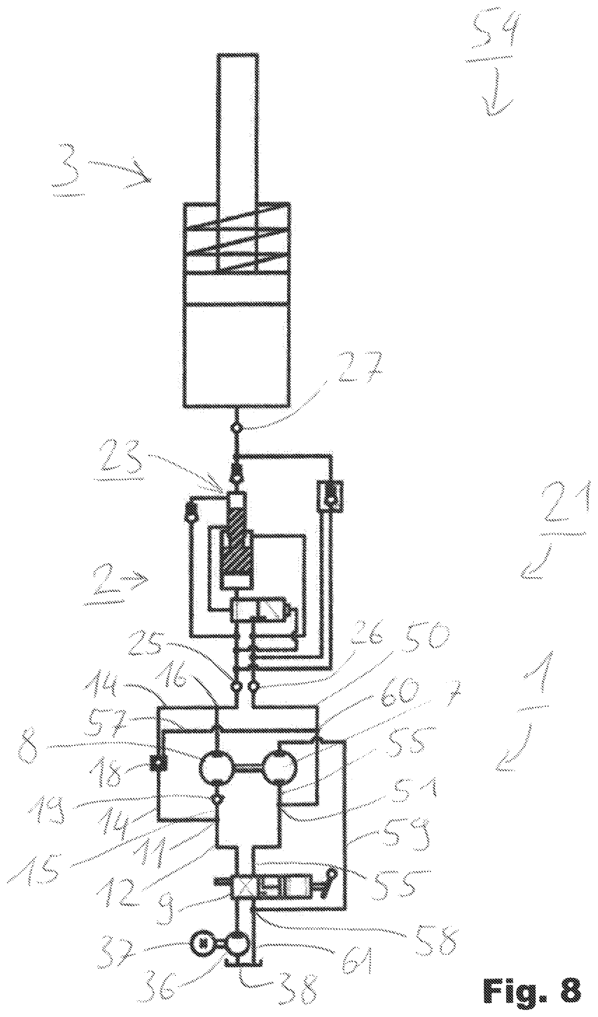

A first exemplary embodiment is explained with reference to FIGS. 5 and 6. A further exemplary embodiment of a pre-switching system 21 is shown in FIGS. 7 and 8.

Thereby the two exemplary embodiments only differ in the design of their pre-switching device 1. The pressure transformer 2, on the other hand, is designed in the same manner in both exemplary embodiments.

In such a pre-switching system 21, the hydraulic cylinder 3 is not fed directly with the aid of the hydraulic pre-switching device 1, but rather via the pressure transformer 2, which is adapted to the invention or is specifically controlled with the aid of the invention. With the help of the pressure transformer 2 the pressure with which the hydraulic fluid is pumped into the hydraulic cylinder 3 during feeding increases.

The pre-switching device 1 in such a pre-switching system 21 functions similarly to that already described above with reference to FIGS. 1-4 and is explained below with reference to FIGS. 5-8.

First, a pre-switching system 21 will be described with reference to FIGS. 5 and 6, the pre-switching device 1 of which is designed essentially like the pre-switching system 1 shown in FIGS. 1 and 2.

In contrast to the pre-switching device 1 shown in FIGS. 1 and 2, however, a further hydraulic line 50 is provided here, which is connected to the hydraulic line 55 at node 51.

In order to supply the hydraulic cylinder 3 with hydraulic fluid, the reversing valve 9 is in its first position. This ensures that the hydraulic fluid pumped by the feed pump 36 from the tank 38 under feed pressure in the direction of the reversing valve 9 continues to flow in the direction of the hydraulic line 12.

From there, the hydraulic fluid flows further in the direction of the hydraulic node 11 and, because of the check valves 17 and 19 present in the lines 13 and 15, further through the hydraulic line 14. The check valve 18 which is arranged in the hydraulic line 14 then opens the way in this direction and is further flown through in the direction to the hydraulic node 16.

From there, the hydraulic fluid can continue to flow along the hydraulic line 14, which continues in the direction of the pressure transformer 2, and through the hydraulic line 15 in the direction of the discharge pump 8.

As already described in the above exemplary embodiment, a check valve controlled by a pre-switching valve can also be provided between the hydraulic node 16 and the discharge pump 8, which blocks the flow of hydraulic fluid in this direction during the feeding process.

If such a check valve is not provided, the hydraulic fluid continues to flow to the check valve 19, which is kept in the closed position due to the hydraulic fluid under feed pressure on its side facing the node 11.

The hydraulic fluid flowing through the continuation of the hydraulic line 14 finally arrives at the connection 25 of the pressure transformer 2 under feed pressure.

In the pressure transformer 2, the hydraulic fluid arriving at connection 25 under feed pressure is directed further in the direction of the hydraulic cylinder 3, so that the hydraulic cylinder 3 is fed with hydraulic fluid via its connection 10.

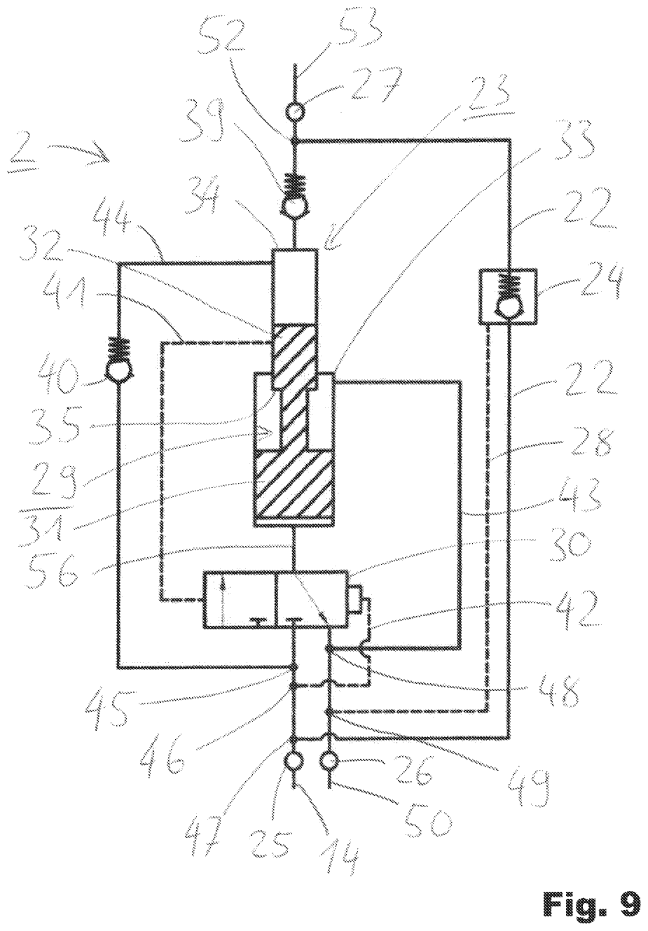

With the help of the pressure booster element 23, the pressure acting on the hydraulic fluid is increased multiple times, so that the hydraulic cylinder 3 is not fed with the feed pressure generated by the feed pump 36, but rather with a significantly higher working pressure depending on the exact design of the pressure booster element 23. The exact processes in the pressure transformer 2 are explained below with reference to FIGS. 9 to 12.

In order to withdraw the hydraulic fluid in the hydraulic cylinder 3 from the hydraulic cylinder 3 after the lifting movement of the piston 6 and the piston rod 4, the reversing valve 9 is brought into a different position.

This condition is shown in FIG. 6.

The feed pump 36 continues to pump hydraulic fluid from the tank 38 in the direction of the reversing valve 9. The hydraulic fluid is forwarded from the reversing valve 9 in the direction of the hydraulic line 55.

The hydraulic fluid then flows further under feed pressure in the direction of the hydraulic node 51. There the hydraulic fluid is transferred via the continuation of the hydraulic line 55 further in the direction of the hydraulic motor 7 and via the hydraulic line 50 further in the direction of the second connection 26 of the pressure transformer.

The hydraulic fluid flowing via the hydraulic line 50 and the connection 26 continues to flow inside the pressure transformer 2 via the pre-switching line 28 in the direction of the pre-switching valve 24.

There, the hydraulic fluid arriving under feed pressure ensures that the valve 24 opens and now represents a bypass for the hydraulic fluid flowing back from the hydraulic cylinder to the tank to bypass the actual pressure transformer.

The hydraulic fluid flowing via the hydraulic motor 7 drives the hydraulic motor 7, which in turn puts the discharge pump 8 into operation. This ensures that the unloading pump 8 generates a negative pressure.

Since, as described above, the valve 24 is open at this point in time, due to the negative pressure generated by the discharge pump 8, hydraulic fluid is sucked out of the hydraulic cylinder 3 via the hydraulic line 53 through the connection 28 and through the hydraulic lines 22 and 14, which are connected to one another at the hydraulic node 46 and is pumped by the unloading pump 8 via the hydraulic lines 15 and 12 in the direction of the reversing valve 9 and from there in the direction of the tank 38.

In order to ensure that the hydraulic fluid flowing from the hydraulic cylinder 3 via the hydraulic line 53 does not flow in the direction of the pressure booster element 23, a check valve 39 is provided behind the hydraulic node 52, which blocks the flow of current in this direction.

The reversing valve 9 being equipped with three different switching positions, preferably sequentially switchable, namely
Switching position 1 “Connection 25 of the DÜ (=pressure transformer) to feed pressure and port 26 of the DÜ to tank pressure”
Switching position 2 “Port 25 of the DÜ (=pressure transformer) and port 26 of the DÜ both at tank pressure”
Switching position 3 “Connection 25 of the DÜ (=pressure transformer) to tank pressure and port 26 of the DÜ to feed pressure”

in its switching position 2 ensures that the hydraulic cylinder is kept under pressure, but is not put under any further pressure or that the pressure transformer does not continue to run uselessly.

This is because as soon as both connections 25, 26 of the pressure transformer are simultaneously placed under tank pressure, the pressure booster piston can no longer move back and forth.

Thereby all of the check valves installed are designed in such a way that they do not allow the pressurized hydraulic fluid to flow out of the hydraulic cylinder despite the pressure transformer being at a standstill.

This also makes it clear what is meant by a sequential switchability of the reversing valve 9: From its central position, in which the pressure in the hydraulic cylinder and thus its position is maintained without the pressure booster running, the reversing valve can optionally be moved in a first direction, in which it allows the pressure booster to start up again in order to extend the hydraulic cylinder even further or to continue the hydraulic stroke.

Alternatively, it can be moved in a second direction, in which it ideally allows the hydraulic cylinder to retract again, bypassing the pressure booster, which is still stationary. The entire control is purely hydraulic, which works without—ideally completely without or at least essentially without—additional operating current or other non-hydraulic auxiliary energy, for example for electrically operated valves.

Finally, another pre-switching system 21 will be described with reference to FIGS. 7 and 8. In this case, a pre-switching device 1 is provided, which functions similarly to the pre-switching device 1 shown in FIGS. 3 and 4.

Since the pressure transformer 2 is designed in the same way as in the exemplary embodiment shown in FIGS. 5 and 6, elements of the pressure transformer 2 are not all provided with reference numbers for better representation.

When the reversing valve 9 is in the position shown in FIG. 7, hydraulic fluid is pumped from the feed pump 36 through the hydraulic line 12 under feed pressure in the direction of the node 11. The hydraulic lines 12, 14 and 15 meet at node 11.

Since the check valve 19 is provided in the line 15, which blocks the further flow of the hydraulic fluid in the direction of the discharge pump 8, the hydraulic fluid flows through the line 14 further in the direction of the pre-switching valve 18.

This is controlled by the pre-switching line 57 and is in a state in which it allows the hydraulic fluid to continue to flow in the direction of the hydraulic node 16, if the position of the reversing valve 9 is as shown in FIG. 7.

From there, the hydraulic cylinder 3 is fed in the same way as in the exemplary embodiment shown in FIGS. 5 and 6.

As soon as the reversing valve 9 is brought into the position shown in FIG. 8, the hydraulic line 12 is connected to the tank 38 and the feed pump 36 pumps hydraulic fluid through the line 55 in the direction of the node 51.

The hydraulic fluid flows from there on the one hand further via the continuation of the line 55 in the direction of the hydraulic motor 7 and on the other hand through the hydraulic line 50 further in the direction of the node 60.

The hydraulic fluid flowing through line 55 passes through the hydraulic motor 7, which drives it, and then continues to flow via line 59 in the direction of node 58. Lines 59 and 61 meet at node 58, so that the hydraulic fluid can flow via line 61 to the tank.

Part of the hydraulic fluid flowing through the line 50 to the node 60 flows further through the continuation of the line 50 in the direction of the connection 26 of the pressure transformer 2.

Since the pressure transformer 2 in the exemplary embodiment shown in FIGS. 7 and 8 is constructed in the same way as in 5 and 6, applying hydraulic fluid under feed pressure to the connection 26 leads to the same processes as in the exemplary embodiment described with reference to FIGS. 5 and 6.

The pre-switching valve 24 is therefore brought into a state that allows the hydraulic fluid located in the hydraulic cylinder 3 to flow to the connection 25. The connection 25 is at the tank pressure level in the position of the reversing valve 9 shown in FIG. 8.

The other part of the hydraulic fluid arriving at node 60 flows through the pre-switching line 57 to the pre-switching valve 18. The hydraulic fluid under feed pressure ensures that the pre-switching valve 18 is closed.

The hydraulic motor 7 drives the unloading pump 8, which, as in the example above, generates a negative pressure. The negative pressure leads to the hydraulic fluid in the hydraulic cylinder 3 being pumped out through the pre-switching valve 24 in the direction of the connection 25 and the node 15 to the unloading pump 8.

From there, the hydraulic fluid is pumped through the check valve 19, which releases this direction, and the line 12 to the tank 38. Since the pre-switching valve 18 is closed at this point in time, as already described, the hydraulic fluid cannot flow back to the node 16 via the line 14.

The exact processes in the pressure transformer 2 adapted to the invention are explained below with reference to FIGS. 9 to 12.

In FIG. 9 shown is the state of the pressure transformer 2 or the pressure booster element 23, which is in operation, i.e. alternately executing compression and charging cycles, at a late point in time in a charging cycle, in which the pressure booster piston 29 moves downwards but not yet at its peak has reached bottom zero point.

Feed pressure is applied to connection 25 and thus to nodes 47, 46, 45 via the hydraulic line 14. Hydraulic fluid under feed pressure flows into the high-pressure cylinder 34 via the hydraulic line 44 and the opened check valve 40.

Tank pressure is applied via the hydraulic line 50 to the connection 26 and thus to the nodes 49, 48 and (because of the corresponding position of the reversing valve 30) also to the low-pressure cylinder.

It should be noted at this point that still hydraulic fluid that is under tank pressure is enclosed in the control line 41 at this point in time. Therefore, the feed pressure applied via the node 46 on the (here) right side of the reversing valve 30 holds the reversing valve 30 in its position shown in FIG. 9.

Since there is a higher pressure in the high-pressure cylinder with the feed pressure than the dynamic pressure that pushes the hydraulic fluid back from the low-pressure cylinder into the tank, the pressure booster piston is pushed even further towards its bottom zero point.

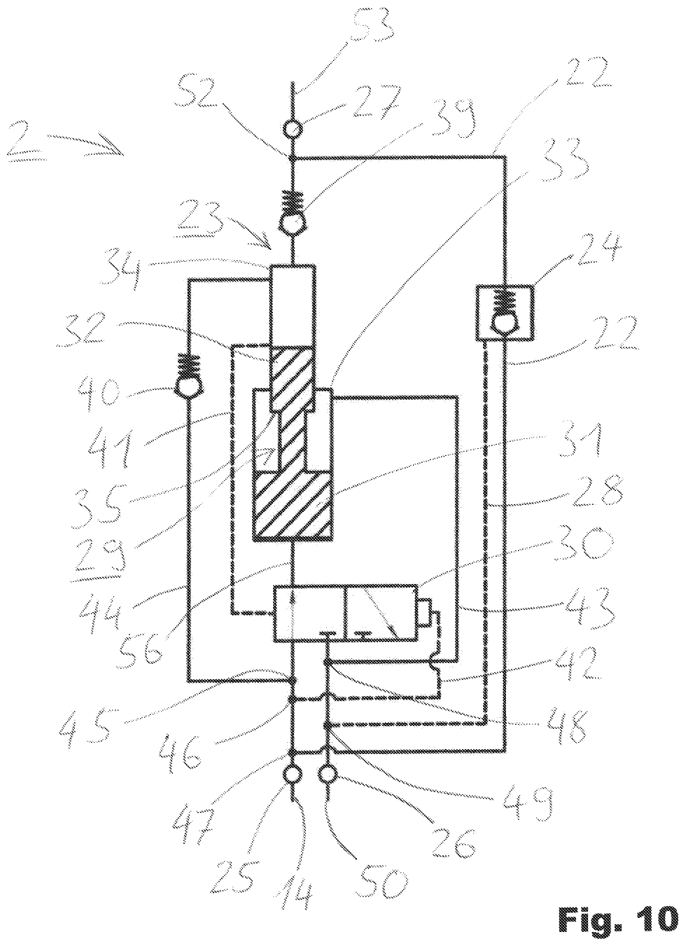

As soon as the pressure booster piston 29 has assumed the position shown in FIG. 10, the control line 41 is no longer covered by the high-pressure piston 32 of the pressure booster piston 29.

The hydraulic fluid located in the high-pressure cylinder 34 and still under feed pressure at this time therefore flows through the control line 41 into the reversing valve 30. There it acts on the end face of the displacement piston of the reversing valve 30 facing the control line 41 with hydraulic fluid under feed pressure.

Since the end face of the displacement piston of the reversing valve 30 facing the control line 41 is larger than the end face facing the control valve 42, which is also pressurized with feed pressure of the hydraulic fluid, the force pressing the displacement piston in the direction of the control line 42 is greater than that force pushing the displacement piston in the direction of the control line 41. This brings the reversing valve 30 into the position shown in FIG. 10.

The hydraulic fluid which is under feed pressure and flowing through the hydraulic line 14 and arriving at the connection 25 of the pressure transformer 2 can flow in this position through the reversing valve 30 into the low-pressure piston 33 of the pressure booster element 23.

The low-pressure piston 31 is then acted upon at its end face with hydraulic fluid under feed pressure. At this point in time, feed pressure is also present on the opposite end face of the high-pressure piston 32.

Since the end face of the high-pressure piston 32 is smaller than the end face of the low-pressure piston 31, the pressure booster piston 29 is moved in the direction of the high-pressure cylinder 34 towards its top zero point. So now a compression cycle takes place.

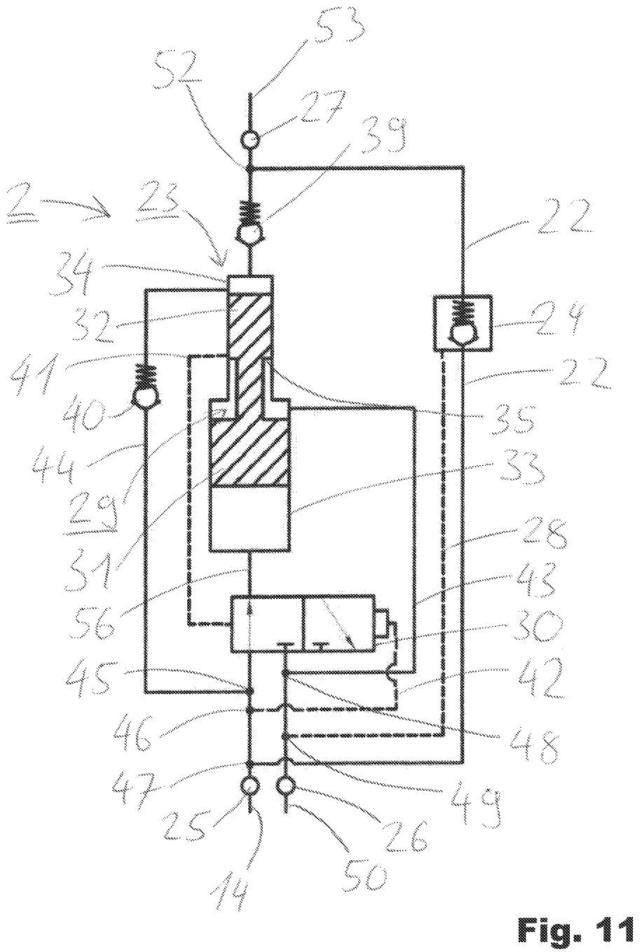

In FIG. 11 it is shown how things behave just before the pressure booster piston 29 reaches its top zero point.

As before, the high-pressure piston 32 exerts pressure on the hydraulic fluid located in the high-pressure cylinder 34. The resulting pressure in the high-pressure cylinder 34 is greater than the feed pressure applied by the feed pump 36 by a factor that is formed from the quotient of the end face of the low-pressure piston 31 by the end face of the high-pressure piston 32.

This pressure created in the high-pressure cylinder 34 represents the working pressure. Since the hydraulic fluid located in the high-pressure cylinder 34 cannot flow back through the hydraulic line 44 because of the check valve 40, it flows on through the check valve 39 to the hydraulic node 52.

The valve 24 only releases the flow in the direction of the hydraulic node 47 when it is supplied with hydraulic fluid under feed pressure through the pre-switching line 28.

However, since in the states shown in FIGS. 9 to 12 the reversing valve 9 of the pre-switching device 1 is in the first position shown in FIGS. 5 and 7, only tank pressure is present on the pre-switching line 28.

The valve 24 thus remains closed and the hydraulic fluid under working pressure arriving at the hydraulic node 52 can only flow through the hydraulic line 53 in the direction of the hydraulic cylinder 3.

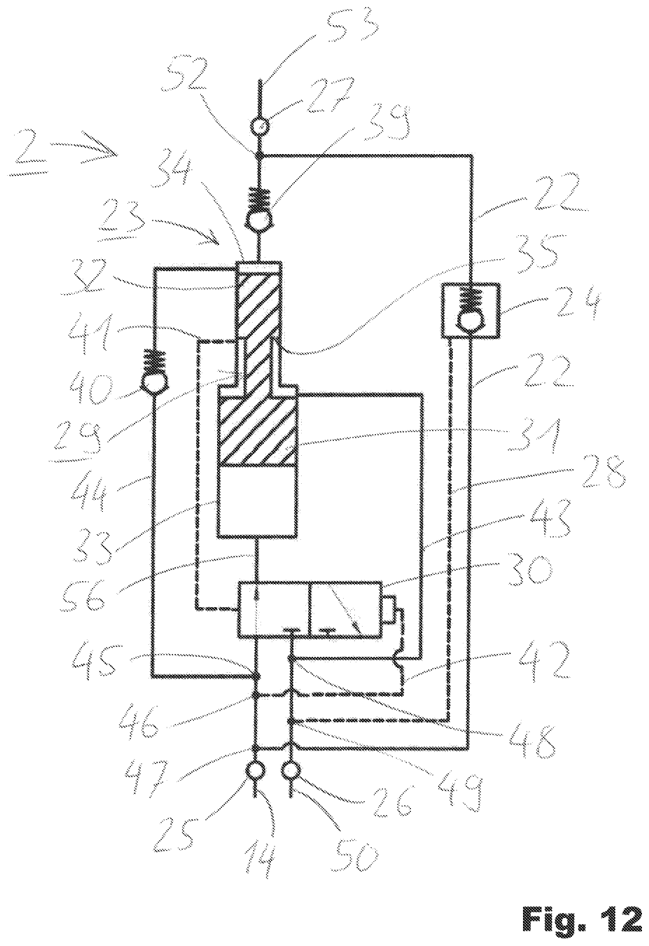

FIG. 12 shows the situation when the pressure booster piston 29 reaches its top zero point.

As you can see, at the transition from the high-pressure piston 32 to the low-pressure piston 31, a shaft shoulder 35 is provided, which has a smaller diameter than the high-pressure piston 32 and also the low-pressure piston 31. This shoulder ensures a free space between the high-pressure and the low-pressure piston among other things, which is in order to drain any leakage that may collect here via the hydraulic line 43 permanently at tank pressure.

In the situation shown in FIG. 12, the high-pressure piston 32 has moved up so far that its lower edge has released the mouth of the control line 41 located on the side of the high-pressure cylinder.

The control line 41 sees tank pressure for the first time during the compression stroke. This means that the pressure previously applied to the left side of the reversing valve 30 collapses, so that the reversing valve 30 is switched under the influence of the tank pressure applied to its right side via the node 46, namely here it is moved to the right, as already shown in FIG. 12.

This switching of the reversing valve 30 brings the low-pressure cylinder 33 to tank pressure. This initiates its downward movement, i.e. its charging cycle. Things are now happening again as already described with reference to FIG. 9.

The following facts, which are independent of the exemplary embodiments shown, should be emphasized:

It should be said that the box shown in dashed lines in FIG. 5 and FIG. 6 around the pressure transformer preferably represents its metal block—within which ideally all or all of the elements of the pressure transformer shown here are accommodated.

This box has not been shown in FIGS. 7 and 8. Here too, however, the elements of the pressure transformer 2 are ideally all located within a corresponding metal block.

Ideally, the pressure transformer communicates with the or each hydraulic cylinder or its connection 10 only via a single hydraulic line 53.

Ideally, it communicates with the pre-switching device via two hydraulic lines 14 and 50.

As a rule, the pressure transformer obtains the hydraulic fluid it needs to work as intended under feed pressure entirely via the pre-switching device 1. The situation is no different with the hydraulic fluid that the pressure transformer returns to the tank. The return then takes place entirely via pre-switching device 1.

Typically, the pressure transformer has its own external actuator. Ideally, only the reversing valve or path control valve 9 of the pre-switching device is used for its external control or actuation.

For some applications it is particularly advantageous if the pressure transformer and the pre-switching device are both designed in a common block. For other applications, their block separation can be of particular importance.

Ideally, the working cycle of the pressure transformer is determined by a completely hydraulically driven reversing valve, which assumes a specific switching position depending on the pressure-generated force difference between its pressure-exposed end faces.

It is also particularly advantageous that the discharge pump does not require any electrical or other non-hydraulic auxiliary energy, but is driven solely by the hydraulic fluid that is already available under feed pressure.

It should also be noted that the pressure booster piston can in principle be designed in one piece—as shown in FIGS. 5-12. However, it is advantageous and should also be covered by the invention if the low-pressure piston and the high-pressure piston of the pressure booster piston are designed in two parts.

1. A hydraulic pre-switching device for feeding a single-acting hydraulic cylinder with working pressure hydraulic fluid directly or via a pressure transformer and for actively withdrawing used hydraulic fluid from the hydraulic cylinder when retracting a piston rod, wherein the pre-switching device comprises:
a hydraulic motor and a discharge pump coupled to the hydraulic motor;
a reversing valve, wherein the reversing valve and the hydraulic motor are connected in such a way that the reversing valve in a first switching position supplies a connection for the hydraulic cylinder with hydraulic fluid under working pressure, bypassing the hydraulic motor and the discharge pump and, in a second switching position, the hydraulic motor is fed with hydraulic fluid under feed pressure which thereby drives the discharge pump, which applies negative pressure to the connection for the hydraulic cylinder.

2. The hydraulic pre-switching device according to claim 1, wherein the pre-switching device has a first hydraulic node in which:
one end opens into a first hydraulic line, the other end of which is connected to a first pressure level of the reversing valve,
one end of a second hydraulic line opens, the other end of which is connected to a second pressure level of the reversing valve and in which the hydraulic motor is located, with an alternative to the second hydraulic line a further hydraulic line is provided not opening into the first hydraulic node, in which the hydraulic motor is located and one end of which is always at a tank pressure level,
one end opens into a third hydraulic line, the other end of which is connected to the connection for the hydraulic cylinder,
one end of a fourth hydraulic line opens into which an unloading pump is located and the other end of which is connected to the third hydraulic line via a second node.

3. The hydraulic pre-switching device according to claim 2, wherein in the second hydraulic line there is an automatic check valve, which prevents a flow from the first node to the hydraulic motor.

4. The hydraulic pre-switching device according to claim 2, wherein the further hydraulic line provided instead of the second hydraulic line connects the hydraulic motor with a hydraulic node that is permanently at the tank pressure level.

5. The hydraulic pre-switching device according to claim 2, wherein in the third hydraulic line there is a check valve which prevents a flow bypassing the discharge pump from the connection of the hydraulic cylinder to the first node.

6. The hydraulic pre-switching device according to claim 5, wherein the check valve in the third hydraulic line is an externally controlled valve which is controlled by a pre-switching line and is closed as long as there is feed pressure on the hydraulic motor and is open when there is tank pressure on the hydraulic motor.

7. The hydraulic pre-switching device according to claim 2, wherein in the fourth hydraulic line there is an automatic check valve, which prevents a flow from the node through the fourth hydraulic line via the discharge pump.

8. The hydraulic pre-switching device according claim 2, wherein in the fourth hydraulic line between the second node and the discharge pump there is an externally controlled valve, a control line of which is hydraulically connected to the hydraulic motor in such a way that the externally controlled valve is always unlocked when the hydraulic motor is fed with hydraulic fluid under feed pressure.

9. A hydraulic pre-switching system comprising the hydraulic pre-switching device according to claim 2 and a pressure transformer located hydraulically between the hydraulic pre-switching device and the hydraulic cylinder to increase the working pressure of the hydraulic fluid feeding the hydraulic cylinder, wherein a bypass line is provided, via which the unloading pump can withdraw hydraulic fluid from the hydraulic cylinder while completely bypassing the pressure transformer or bypassing the pressure transformer's pressure booster element.

10. The hydraulic pre-switching system according to claim 9, wherein the bypass line is controlled by an externally controlled valve, which remains closed as long as the hydraulic cylinder is fed with hydraulic fluid and which is opened as soon as hydraulic fluid is withdrawn from the hydraulic cylinder.

11. The hydraulic pre-switching system according to claim 9, wherein the pressure transformer is a pressure transformer which draws its working and control energy exclusively from the hydraulic fluid fed in under feed pressure, comprising a first connection on a low-pressure side and a second connection for feeding hydraulic fluid under feed pressure and for discharging hydraulic fluid under tank pressure, as well as a third connection on the high-pressure side for feeding the hydraulic cylinder with hydraulic fluid under increased pressure and for drawing off used hydraulic fluid from the hydraulic cylinder, the pressure transformer being designed in such a way that its operation “filling the hydraulic cylinder” or “withdrawing hydraulic fluid from the hydraulic cylinder” depends on whether the first connection is with feed pressure and the second connection is pressurized with tank pressure or vice versa.

12. The hydraulic pre-switching system according to claim 9, wherein the pre-switching device has a path control valve, a switching position of which not only depends whether the hydraulic motor and the discharge pump are running, but also determines whether the first connection of the pressure transformer sees feed pressure or tank pressure and whether the second connection of the pressure transformer sees tank pressure or feed pressure.

13. The hydraulic pre-switching system according to claim 9, wherein the hydraulic pre-switching device has a further hydraulic line, which has one end upstream of the hydraulic motor where the further hydraulic line branches off from a mesh, in which the hydraulic motor is located and which is connected at its other end to the low-pressure side connection of the pressure transformer, which is at low pressure when filling the hydraulic cylinder and when emptying the hydraulic cylinder to feed pressure.

14. The hydraulic pre-switching system according to claim 13, wherein a pre-switching line that controls a check valve, that is an externally controlled valve, in the third hydraulic line branches off from the further hydraulic line, from the internal pressure of which it depends whether the externally controlled valve realized as a pre-switching valve, which controls the fourth hydraulic line, is open or closed.

15. The hydraulic pre-switching system according to claim 9, wherein the bypass line is designed completely within a block of the pressure transformer, within which also a pressure booster piston is located and also a reversing valve, which determines working cycles of the pressure booster piston in pressure-boosting operation, while the hydraulic pre-switching device is designed separately from the reversing valve.

16. A hydraulic working arrangement consisting of a single-acting hydraulic cylinder and the hydraulic pre-switching device according to claim 1, wherein the single acting hydraulic cylinder is connected to the hydraulic pre-switching device.

17. A method for accelerated retraction of a hydraulic cylinder fed with the aid of a pressure transformer, comprising:
bypassing a pressure transformer or a pressure booster element of the pressure transformer when pumping hydraulic fluid out from the hydraulic cylinder by opening a bypass line, and
when driving the hydraulic fluid back into the hydraulic cylinder, starting a discharge pump, which, using a bypass line, directly, without detouring via the pressure booster element, removes used hydraulic fluid from the hydraulic cylinder.

18. The hydraulic pre-switching system according to claim 9, wherein the bypass line comprises a differential piston-shaped pressure amplifier piston.

19. The hydraulic pre-switching system according to claim 10, wherein the externally controlled valve is in the form of a pre-switching valve controlled by the feed pressure.
